(19) United States
(12) Patent Application Publication
(10) Pub. No.: US 2017/0145692 A1
(43) Pub. Date: May 25, 2017

(54) Finish-Ready Structural Insulating Panels

(71) Applicant: Vantem Composite Technologies, LLC, Boston, MA (US)

(72) Inventors: Chun Ke Zheng, Suxi (CN); Cato Wang, Hangzhou (CN); Chris Anderson, Browns Summit, NC (US)

(21) Appl. No.: 14/950,274

(22) Filed: Nov. 24, 2015

(51) Int. Cl. E04C 2/296; B32B 5/02; B32B 5/18; B28B 3/12; B32B 13/14; B32B 27/06; B32B 27/12; B32B 27/30; E04B 2/00; B32B 13/04

(52) U.S. Cl. CPC E04C 2/296; E04C 2/46; B32B 5/028; B32B 5/18; B32B 13/045; B32B 13/14; B32B 27/065; B32B 27/12; B32B 27/302; B28B 3/123; B32B 2262/101; B32B 2266/0228; B32B 2307/304; B32B 2607/00

(57) ABSTRACT

A reinforced tapered edge cementitious skin for use in a SIP panel provides a recessed edge having an underlying reinforcing web. When panels having the reinforced tapered edges are to be joined together and fastened to underlying shims, the resulting joint has both structural integrity and a recess for receiving joint compound that can be made flush with the skins.

### FIELD OF INVENTION

This invention relates to structural insulating panels and more particularly to a chamfered reinforced edge for the panels to provide a finish-ready surface.

### BACKGROUND OF THE INVENTION

Structural insulated panels or SIPS have been in existence since the 1930s in which stress skinned panels have been used for construction. Frank Lloyd Wright was a pioneer in the use of SIPs in an effort to incorporate beauty and simplicity into cost-effective homes. Wright's attempt at the panel contained no insulation; they consisted of layers of plywood and layers of tarpaper. Alden B Dow, an architecture student of Frank Lloyd Wright, experimented with providing proper insulation for the SIPs and created a structural panel with an insulated core in 1950. Dow's earliest SIPs were composed of 1⅝ inch Styrofoam cores with plywood facings to add structural support for loadbearing walls.

In general, the structural insulated panel is a composite building material consisting of an insulating layer of rigid core sandwiched between two layers of structural board. The board can be made of sheet metal, plywood, cement, magnesium oxide board (MgO) or oriented strand board (OSB) in which the core is typically expanded polystyrene foam or EPS. While the SIPs share the same structural properties of an I-beam or I column, the rigid insulating core acts as a web, whilst sheathing fulfills the function of the flanges.

When these panels are placed side by side, a finished surface usually requires covering over the joint between adjacent panels with a fiber tape and applying a compound over the tape. However, this traditional joint treatment creates material build up between the adjacent edges of the board that stands proud of the surface and presents a hump which must be sanded down in order to provide a smooth finish-ready surface on which stucco or paint may be applied.

In summary, the most difficult step in finishing SIPs is treating the joint between the panels before painting. This is done by laying a fiber tape over the joint and applying a joint compound over it. This is a traditional treatment for nonstructural drywall and fiber cement boards that are used as interior and exterior sheathing.

In the past, nonstructural drywall and some fiber cement boards have been provided with tapered edges that allow the application of tape and joint compound without creating material build up that stands proud of the surface. Structural boards used to manufacture SIPs, such as OSB, do not usually have tapered edges because they are covered by another finish layer, such as exterior cladding or drywall. Therefore the joints of the SIP are not finished and do not require a taper. For SIPs that are not covered by another layer, such as SIPs made with MgO boards, the tapered edges are provided by cutting a taper in the finished edge of the skin or board which cuts one or more layers of fiberglass mesh that gives the panel structural integrity.

Referring to FIG. 1, a prior art Structural Insulated Panel 10 is provided with a cementitious skin 12 to either side of an insulation core 14. To either edge of the structural insulated panel 10 are provided slots 16 adapted to accommodate shims that interconnect adjacent panels.

Referring to FIG. 1B, adjacent SIP panels 10 as illustrated in FIG. 1A are provided with shims 20 in associated slots 16 in the opposed edges of the panels 10 to be joined. Fasteners in the form of screws 22 penetrate cementitious skins 12 and shims 20 so that the adjacent panels 10 can be joined together as is practiced in the prior art.

Referring to FIG. 2, adjacent panels 10 are secured as illustrated in FIG. 1B by shims 20 and screws 22, with the result being an open joint 24 which must be covered over to provide a finished wall or panel, as practiced in the prior art. Typically tape 26 overlies slot 24, over which a joint compound 28 is deposited that bridges the adjacent panels 10. Unfortunately the joint compound forms a hump over the joint. Because this joint compound stands proud of the surface of the skins of the SIP panels it must be sanded down which is an arduous process in order to complete a finished surface.

FIG. 3A is a diagrammatic and cross-sectional illustration of a prior art panel skin 12 having mesh reinforcing webs 30 on either side of the skin. SIP panel skin 12 has two or more fiber mesh reinforcing webs 30 just under the surfaces of the skin 12. These reinforcing webs 30 provide structural integrity.

FIG. 3B is a diagrammatic illustration of the joining together of two prior art SIP panels 12, illustrating including the utilization of screws 22 through the SIP skins 12 and into underlying shims 20 as well as tape 26 and joint compound 28 over the joint 24. SIP skins 12 sandwich the insulating core 14, which may be expanded polystyrene foam or EPS. In this embodiment, the SIP skins 12 are magnesium oxide skins, with the cementitious material being particularly effective in the manufacture of these panels. It can be seen that these panels are joined together by screwing the skins 12 to underlying shims 20, with the shims 20 having been previously positioned into slots 16 at the edges of the associated insulating cores 14. Screws 22 penetrate the associated skins 12 and project into the underlying shims 20. It will be appreciated that the screws 22 pass through reinforcing webs 30 in each of the skins 12, with the reinforcing webs 30 providing structural rigidity to the joint here shown at 24. It will be noted that finishing of the panels includes tape 26 and joint compound 28 which stands proud of skin surface 32 of upper skin 12.

Referring to FIG. 4A, a chamfered skin 40 alternative to skin 30 of FIG. 3A is illustrated. The chamfered skin 40 is shown having a cut chamfer 42 that provides a recess at the surface of an edge portion of the skin 40, with the chamfer being provided by cutting portions of the skin 40 including reinforcing mesh webs 44, as illustrated. When the board edge is sawn, and the board has two mesh layers, one would be removing at least a portion of one of the two layers. When the board has 4 mesh layers, the positioning of all 4 layers is not absolutely exact and varies a bit. Thus, one may be sawing away portions of 1 layer or 2 layers.

Referring to FIG. 4B, when this chamfered skin 40 is utilized in the joining of SIPs 10, screws 22 penetrate skin 40, with the heads of the screws 22 not engaging any reinforcing material as the reinforcing webs 44 have been cut away in order to provide the chamfer 42. Thus the reinforcing mesh 40 is cut off in providing chamfer 42 as is practiced in the prior art.

Referring to FIG. 4C, SIPs 10 with the chamfered skins 40 are shown joined together utilizing screws 22 with the heads of the top screws 22 penetrating skin 40 are not reinforced by any underlying reinforcing mesh webs 44. While it is true that tape 26 may be used to cover up slot 24 and while joint compound 28 may be deposited in the chamfered edge to provide a smooth finish surface, the joint provided by such an arrangement is not structurally sound due to the removal of portions of layer(s) of underlying reinforcing mesh 44.

Thus, while these tapers provide a recessed edge, the cutting weakens the board so much that the joints between the boards are not robust. Since the boards are produced with two main components, one for instance an MgO cement which gives the board compressive strength; and one or more layers of fiberglass mesh that gives the board tensile strength and flexural strength, when the board is cut, one or more layers of the fiberglass mesh are removed eliminating a key element that gives the edges tensile and flexural strength. In short, the structural integrity of the joints is compromised by virtue of providing the recessed edge by cutting a taper in the edge of the SIP panel.

It is noted that MgO boards have been provided with a recessed edge by cutting the edge at an angle with a saw or other cutting tools. This may work for a nonstructural board, but for a structural board the cutting significantly weakens the edge. Since the edges are where the fastening of the panels one to another occurs, the structural integrity of the panel is severely impacted by the use of a chamfered edge provided by cutting the edge of the panel.

Thus, prior to the subject invention, structural panels either do not have recessed edges or, if they do, the edge is not properly reinforced with the proper amount of fiberglass mesh due to the cutting.

### SUMMARY OF THE INVENTION

In order to provide SIPs with a reinforced recessed edge to permit a flush finish-ready surface, the SIP board or skin, in one embodiment a cementitious skin, has tapered molded edges that are reinforced. The boards or skins are manufactured by locating an acrylic mold having raised edges at either side, introducing a cementitious slurry onto the acrylic mold, overlaying the slurry with a reinforcing mesh, in one embodiment a fiberglass mesh, introducing more slurry and providing an additional reinforcing mesh on top of the slurry, followed by calendaring or calibrating the top surface of the slurry with rolls to calendar the slurry into the shape defined by the acrylic mold. The result is a flat surface on the rolled side of the skin and a tapered edge on the underside which is reinforced by fiberglass mesh. The wet board or skin is transported still on the acrylic mold into a curing room, where it dries and hardens, after which it is stripped from the mold to provide a SIP panel skin having reinforced recessed tapered edges corresponding to the raised portions of the acrylic mold in which it was formed.

In short, the skin of the SIP is provided with recessed edges that contain fiberglass mesh layers for proper reinforcement and structural use, with the recessed edges adapted to receive tape and a joint compound in the recess to a level flush with the remainder of the skin. When the reinforced tapered edges of the SIPs are screwed into underlying shims at the edges of adjacent panels to join adjacent panels, the joint has significant structural integrity.

The result is the ability to provide a finish-ready joint that is flush with the skin surface without compromising the structural integrity of the joint which would occur through removal of a reinforcing mesh at the edge.

In summary, a reinforced tapered edge cementitious skin for use in a SIP panel provides a recessed edge having an underlying reinforcing web. When panels having the reinforced tapered edges are to be joined together and fastened to underlying shims, the resulting joint has both structural integrity and a recess for receiving joint compound that can be made flush with said skins.

Moreover, a method is provided for molding a SIP skin so as to provide a tapered recess by using a mold having raised edges; introducing a cementitious slurry onto the mold; embedding reinforcing webbing in the slurry; calendaring the slurry to compress the slurry onto the mold such that the top surface of the slurry is flat and such that the bottom surface of the slurry conforms to the raised edge mold; curing the slurry on the mold; and removing the cured slurry as a SIP skin having a recessed tapered edge that is reinforced with the webbing.

### BRIEF DESCRIPTION OF THE DRAWINGS

These and other features of the subject invention will be better understood in connection with the Detailed Description in conjunction with the Drawings, of which:

FIG. 1A is a diagrammatic illustration of a prior art structural insulated panel, illustrating an insulating core and a cementitious skin, with vertically running slots to accommodate shims between adjacent panels;

FIG. 1B is a diagrammatic illustration of a prior art joining of two adjacent panels of the type described in connection with FIG. 1A, showing the use of shims in associated slots and the screwing of SIP skins into the underlying shims;

FIG. 2 is a diagrammatic illustration of the joint between two prior art panels, illustrating the utilization of tape to overlie the joint, and joint compound over the tape that exists proud of the skin surfaces, with the humped joint compound precluding a flush finished surface without significant sanding;

FIG. 3A is a diagrammatic and cross-sectional illustration of a prior art panel skin having mesh reinforcement to either side of the skin;

FIG. 3B is a diagrammatic illustration of the joining together of two prior art SIP panels, including screws through the SIP skins and into underlying shims as well as tape and joint compound over the joint that stands proud over the joint, precluding a flush finish-ready surface;

FIG. 4A is a diagrammatic illustration of a prior art SIP skin, illustrating a recessed edge in which underlying reinforcing mesh has been cut away and removed to provide the recess;

FIG. 4B is a diagrammatic illustration of the joining together of two prior art adjacent SIPs having chamfered skin edges, illustrating the screwing of the tapered edges to an underlying shim without the benefit of fiber mesh reinforcement, thus offering only limited structural integrity;

FIG. 4C is a diagrammatic illustration of the joining together of the prior art SIPs of 4B, illustrating that while a flush joint can be achieved with the chamfered edges described in FIGS. 4A and 4B, the structural integrity of such a joint is lacking;

FIG. 5A is a diagrammatic illustration of a reinforced tapered edge cementitious skin for use in a SIP in which a recessed edge is provided with a number of layers of underlying reinforcing mesh to provide structural integrity for SIP joining;

FIG. 5B is a diagrammatic illustration of a pair of adjoining SIPs provided with cementitious skins having reinforced tapered edges, illustrating the penetration of screws through the reinforced tapered edges and reinforcing mesh into an underlying shim in a recess in the SIP insulating material;

FIG. 6 is a diagrammatic illustration of a production line for the fabrication of the subject reinforced tapered edge cementitious skins showing the utilization of an acrylic mold into which slurry is deposited followed by calendaring, showing the introduction of mesh into the skin;

FIGS. 7A-7 M show the process steps in the manufacture of a SIP skin utilizing the subject molding technique to provide a reinforced tapered edge SIP skin;

FIG. 8 is a diagrammatic illustration of an extruder for extruding an acrylic insert having raised end portions to provide for the recesses in the edges of a cementitious skin; and,

FIG. 9 is an exploded view of a molded acrylic insert having raised edges.

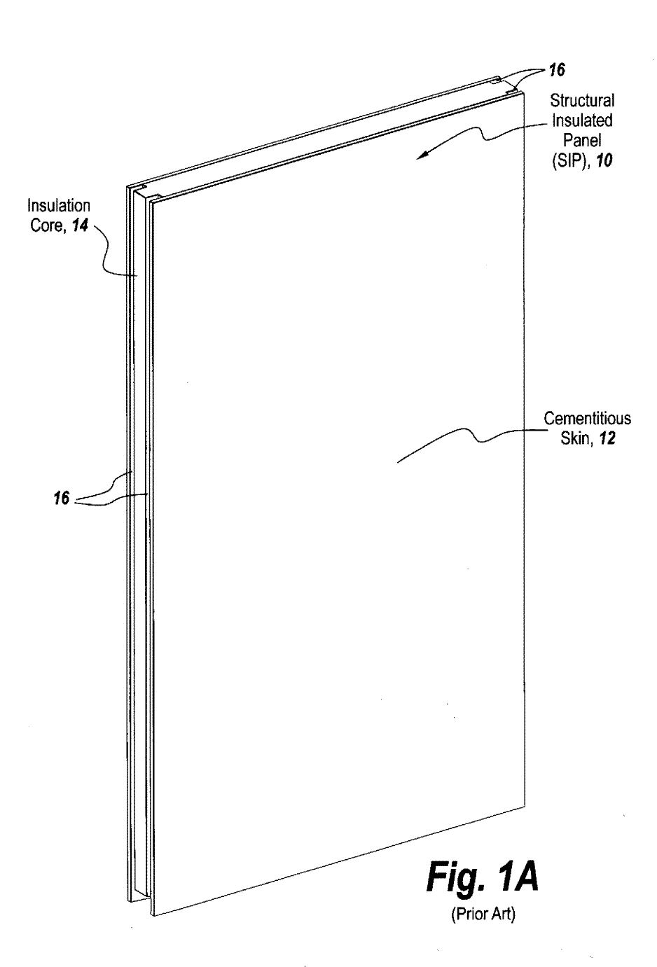

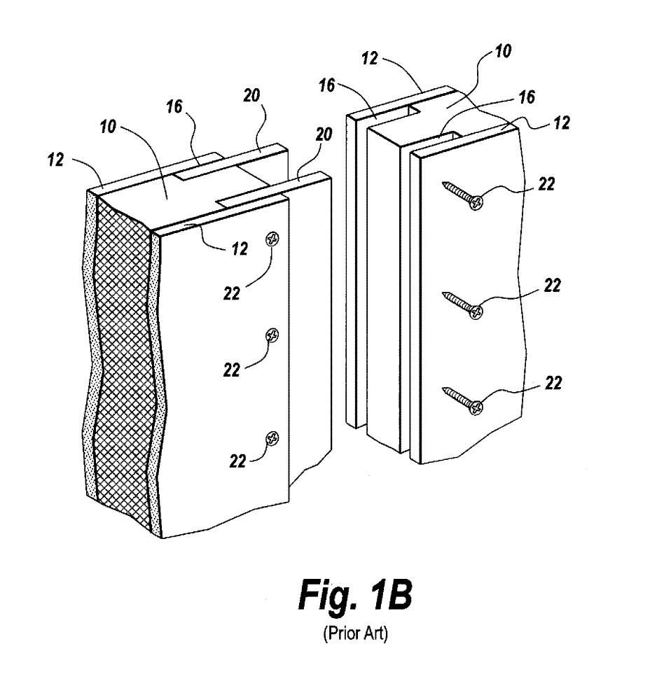

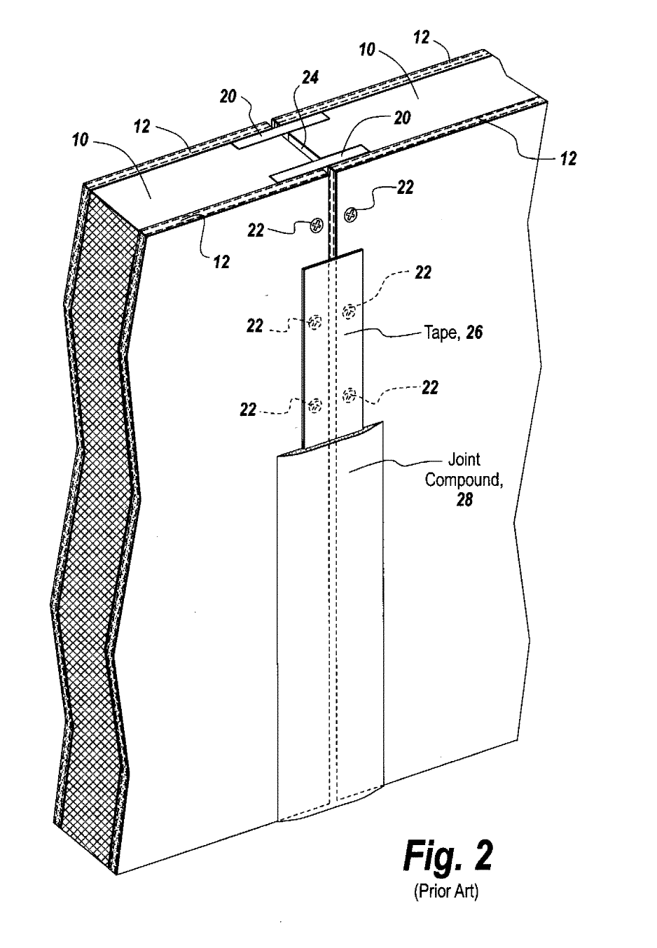

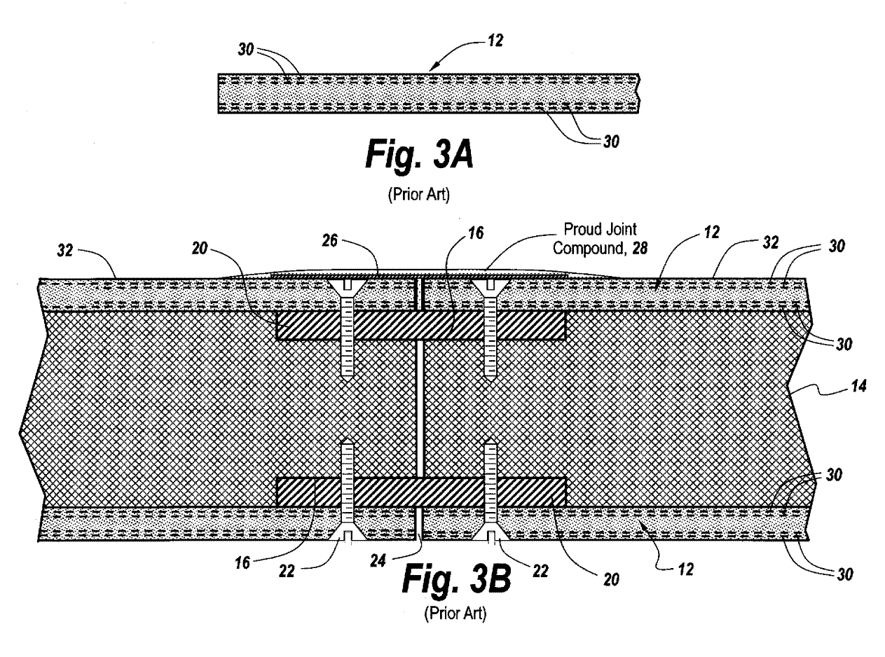

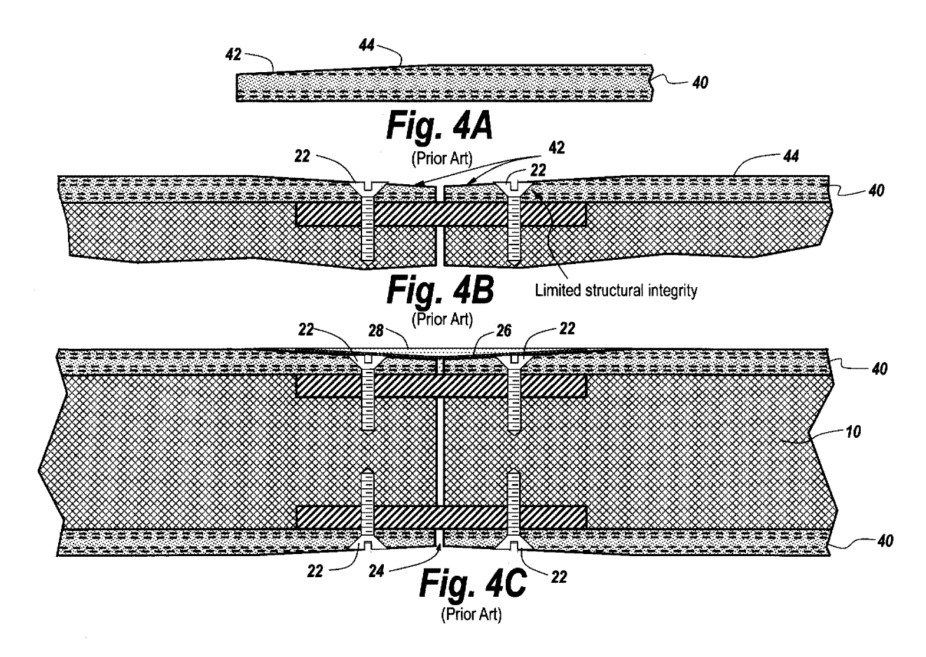

### DETAILED DESCRIPTION

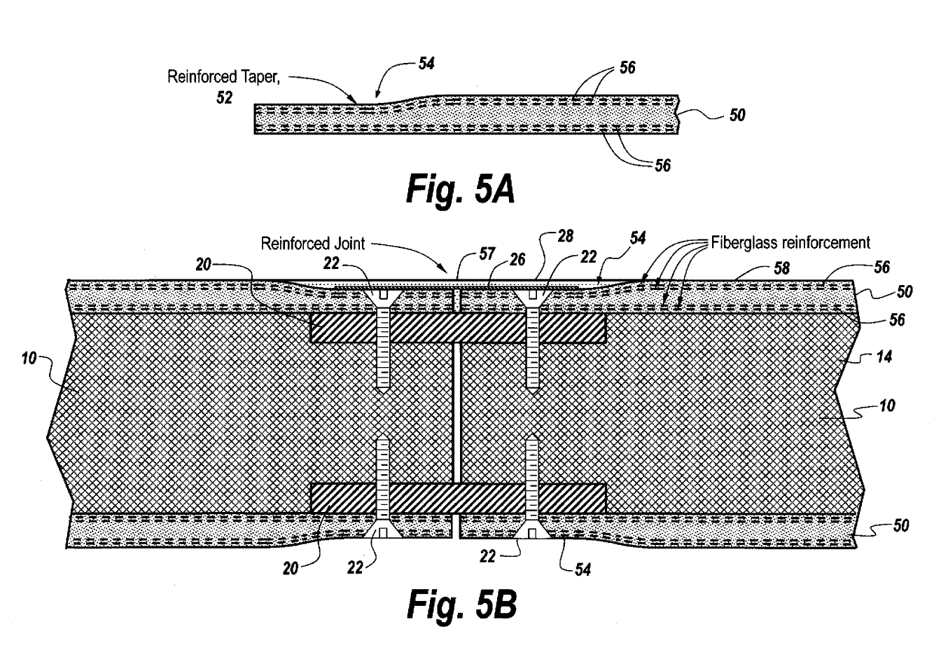

Referring now to FIG. 5A, a SIP skin 50 is provided with a reinforced taper 52 in which the SIP skin is provided with a recess 54. The recess 54 is defined by forming at least opposing edges of the SIP skin 50 more narrowly than a central portion of the SIP skin 50 between the edges. As can be seen, SIP skin 50 is provided with a plurality of layers of reinforcing mesh 56 at both the front side and back side of the SIPs skin 50. More specifically, each reinforcing mesh 56 provided in the SIP skin 50 extends completely from one edge of the SIP skin 50 to the opposite edge of the SIP skin 50 while supporting a recess 54 formed along the edge. The reinforcing mesh 56 is not truncated to form the recess 54. It is the provision of this recess 54 by the molding of the cementitious material used to form the SIP skin and the reinforcement with the multiple layers of mesh web that provides structural integrity to the joint between SIPs.

Referring to FIG. 5B, what is illustrated is the joining together of two SIPs 10 in which an insulating core 14 is sandwiched by the specialized skins 50. Each of these skins has edges that are tapered as illustrated to provide a recess 54. This recess 54 is overlain with tape 26 and joint compound 28 to provide a surface 57 which is flush with surface 58 of SIP skin 50. Here it can be seen that screws 22 penetrate the SIP skin 50 through multiple reinforcing meshes 56 and into shims 20 to join the SIP panels in an exceptionally rugged structurally secure manner. The heads of the screws 22 sit within reinforcing meshes 56. While the FIG. 5B embodiment is shown with skins having four mesh layers, two each at opposing skin surfaces, it will be appreciated that the number of reinforcing mesh layers is a matter of structural design and the design strength of the panels.

The result is that adjacent SIP panels can be joined together securely with SIP skins having mesh reinforced tapered edges to accommodate tape and joint compound to provide flush finishing for the panels.

It will be noted that the subject invention is described in terms of the use of magnesium oxide for the skin material, although other moldable skins having reinforced mesh 56 are within the scope of this invention. Moreover, the shims that are utilized may also be made of magnesium oxide.

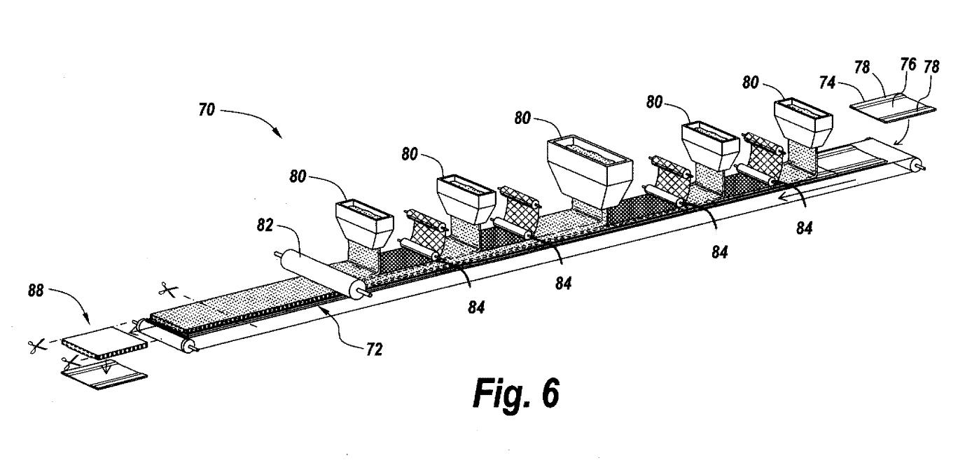

Referring now to FIG. 6, a production line 70 is composed of racks of caged rollers 72 used as a conveyor to transport molds 74 thereon. Each of these molds has a mold surface 76 having raised edges 78 and onto which MgO slurry is deposited from slurry injection funnels 80. Calibrating or calendaring rolls, diagrammatically shown at 82, are used to contact the top surface of the wet slurry on the molds to compress the slurry into the mold as the molds pass beneath these calendaring rolls. Fiberglass mesh rolls 84 at various intervals dispense fiberglass mesh over the slurry carried by the molds as the molds pass underneath so as to provide the resulting skins with the appropriate fiberglass reinforcement.

While the subject invention is described in terms of fiberglass as the mesh utilized for the reinforcement, other reinforcing webs are within the scope of this invention.

After the MgO slurry has been compressed onto the molds by the calendaring rolls, the molds exit the production line as illustrated at 88. Thereafter, the slurry is air cured and the skins with the tapered edges are pulled off of the molds.

From a process perspective, in one embodiment MgO slurry is deposited, then a layer of fiberglass, then another layer of slurry, then anther of fiberglass, etc. The minimum number of fiberglass mesh layers is 2, but there can be up to 4 layers normally, depending on the thickness of the board. The layers are normally toward the surface and the back. That is to say, they are not evenly distributed in the board. Specifically, they are located more toward the surface areas as they are most useful there.

Some of the slurry does drip off of the edges of the mold. However, the MgO slurry has a very high viscosity, so it maintains the desired thickness for all but the last 1-2 centimeters from the edge.

The edge trimming is 3-5 cm. from each edge, so the last bit that is irregular is sawn away. That sawing is done in one embodiment with a double ended trim saw. 5-10 boards are stacked on top of each other and they are run through on a carrousel, between two saws separated at the width the panel is to have, usually 1220 mm. Then another set of saws is set at a 90 degree angle to that of the first trim saws. The second set of saws trim the boards top and bottom.

It will be appreciated that the mold surface provides a raised edge platten onto which the slurry is deposited. As mentioned above, the slurry has sufficient viscosity that, properly metered, does not roll off the mold. After the multiple deposits of slurry along with the fiberglass mesh reinforcement, the skin has a ragged edge. In one embodiment, these ragged edges are trimmed by the above-mentioned double ended trim saws, with the tops and bottoms of the skins being trimmed with trim saws oriented at 90 degrees to the double ended trim saws.

Note that the acrylic sheet is placed directly on the conveyor and is sufficiently rigid, such that it supports the wet MgO skin at the end of the line when it is removed and is placed on racks for drying and curing. The acrylic mold is made approximately 5 cm wider than the final board width, since there are no vertical sides to the molds. Thus, the very ends of the boards are irregular but, because of the high viscosity of the slurry, it holds its shape well enough not to need vertical mold sides. After the board is cured, the edges are cut to remove the irregularity, giving the board its final exact width, and ensuring the edges are perfectly parallel.

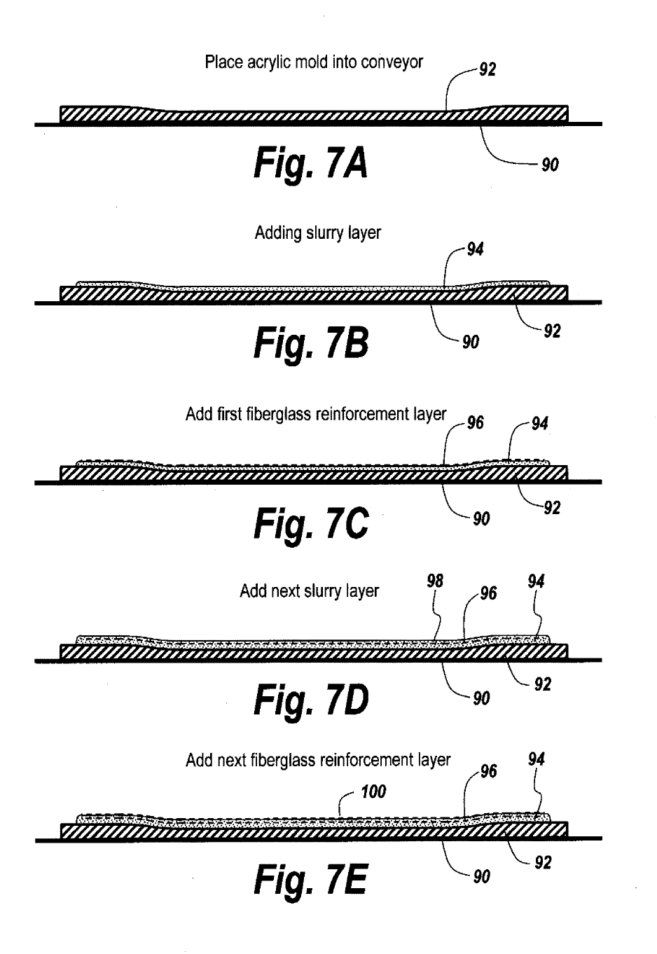

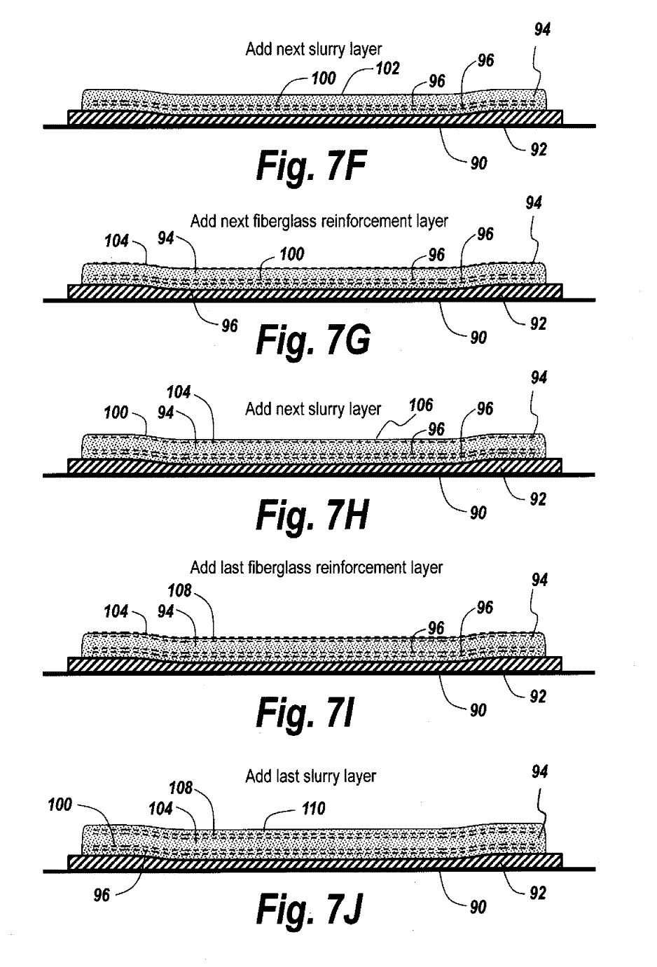

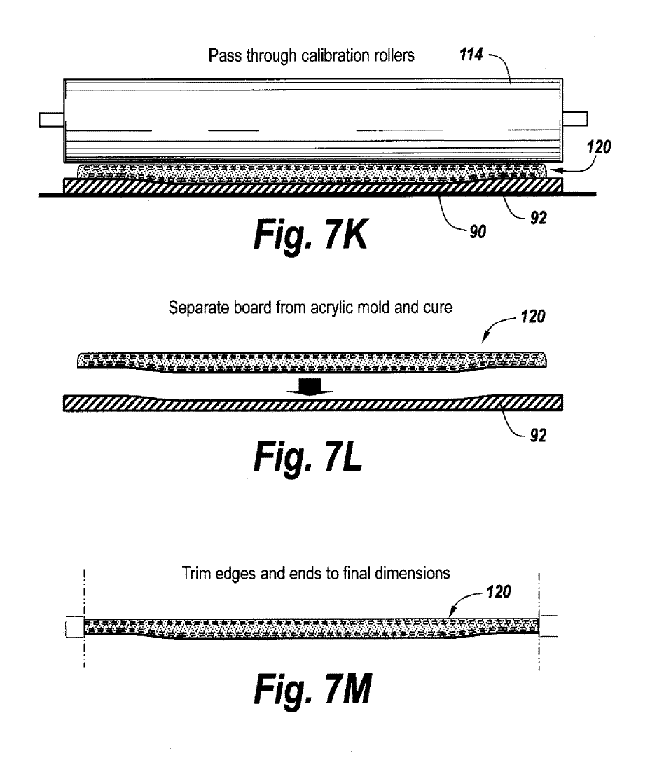

As to the processing, in one embodiment and as illustrated in FIGS. 7A-7L, an acrylic mold 92 is loaded onto a conveyor 90. Thereafter, MgO slurry 94 is deposited over acrylic mold 92. A fiberglass reinforcing mesh layer 96 is then placed over the slurry and further slurry 98 is deposited over top of fiberglass mesh 96. Thereafter, a second fiberglass reinforcing layer 100 is laid down over slurry 98 and further slurry is added as illustrated at 102 on top of the second fiberglass reinforcing layer.

As can be seen in FIG. 7G, an additional fiber glass reinforcing layer is added as illustrated at 104, followed by an additional slurry layer 106. Thereafter, as illustrated in FIG. 71, an additional fiberglass reinforcing layer 108 is added, followed by adding the last slurry layer 110 as shown in FIG. 7J.

As illustrated at FIG. 7K, the slurry built up on mold 92 is calendared by calendar rolls 114 so as to compress the slurry and the reinforcing meshes onto mold 92 to arrive at an MgO skin 120 having mesh reinforced tapered ends. As illustrated in FIG. 7L, after curing, the MgO skin is separated from mold 92, and as illustrated in FIG. 7M the finished skin 120 has its edges trimmed to final dimensions.

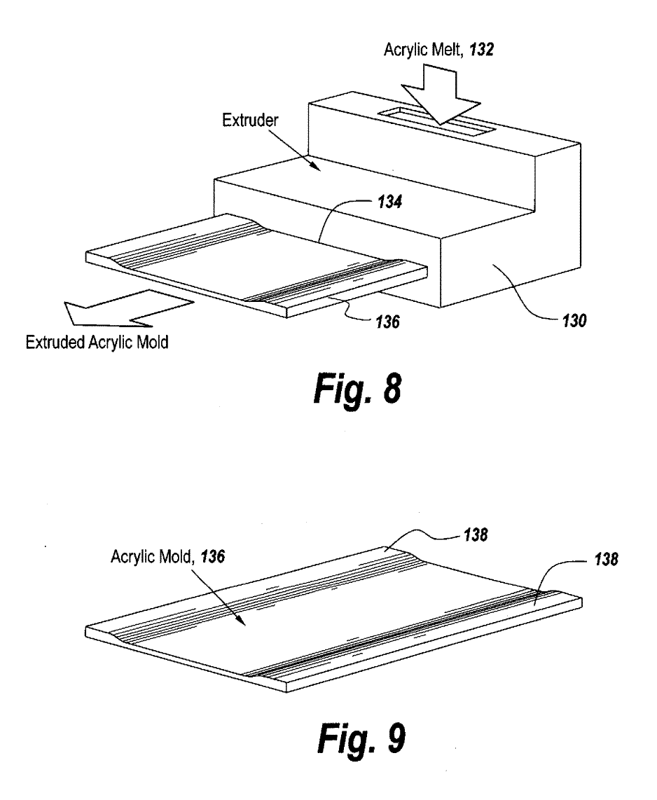

Referring to FIG. 8, in order to provide the acrylic mold, an extruder 130 is provided with acrylic melt 132 and through the molding provided by the extruder at the exit port 134, an extruded product 136 exits, which constitutes the extruded acrylic article. This is an exceedingly cost-effective way of providing a large number of acrylic molds 136 as illustrated in FIG. 9 having raised edges 138.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A novel panel comprising: a SIP panel skin having a plurality of underlying reinforcing mesh layers extending a full width and length of the SIP panel skin, wherein opposing edge portions of the SIP panel skin are narrower than a central portion of the SIP panel skin, whereby when panels having said reinforced tapered edges are to be joined together and fastened to underlying shims, the resulting joint has structural integrity and a recess for receiving joint compound that can be made flush with said SIP panel skins.

2. The novel panel of claim 1, wherein said opposing edge portions include the underlying reinforcing mesh beneath the surface of said opposing edge portions to reinforce said opposing edge portions.

3. The novel panel of claim 2, wherein said underlying reinforcing mesh includes a fiberglass mesh.

4. The novel panel of claim 1, wherein said opposing edges provides a recess such that when a joint having opposed recesses is covered over with a tape and joint compound, a joint compound surface can be made flush with a surface of the central portion to provide a finish-ready surface.

5. The novel panel of claim 1, wherein said SIP panel skin further comprises magnesium oxide.

6. The novel panel of claim 1, wherein said SIP panel skin is fastened to an expanded polystyrene insulating core.

7. The novel panel of claim 6, wherein said core includes a notched channel at an edge thereof and further includes a shim in said notched channel.

8. The novel panel of claim 7, wherein said shim comprises magnesium oxide.

9. The novel panel of claim 1, wherein said SIP panel skins are fastened on opposite sides of an insulating core, said insulating core including a recess, a shim mounted in said recess, and a fastener which penetrates said SIP panel skins and each of the underlying reinforcing mesh layers and is fastened to said shim.

10. The novel panel of claim 9, and further including abutting SIPs having abutting SIP panel skins, shims and fasteners going through abutting edges and into underlying shims to provide a structurally secure joint between said abutting SIPs.

11. A SIP panel comprising a structural SIP panel having reinforced tapered edges that provide a recess adapted to receive joint compound to be smoothed flush with the skin of said panel when adjacent SIP panels are to be joined together.

12. The SIP panel of claim 11, wherein said reinforced tapered edges include embedded reinforcing web.

13. A method of producing skins for a SIP panel, with the skins having reinforced tapered recessed edges, comprising the steps of:
forming a mold having at least two raised edges;
introducing a cementitious slurry onto the mold;
embedding a reinforcing mesh web in the slurry;
calendaring the slurry to compress the slurry onto the mold such that the top surface of the slurry is flat and such that the slurry is compressed onto the mold with the bottom surface of the slurry conforming to the raised edge mold;
curing the slurry on the mold; and
removing the cured slurry as a SIP skin having a recessed tapered edge that is reinforced with the reinforcing mesh web.

14. The method of claim 13, wherein the cementitious slurry comprises magnesium oxide.

15. The method of claim 13, wherein said web comprises fiberglass webbing.

16. The method of claim 13, wherein said reinforcing mesh web exists within the tapered edges of the skin.
